(19) United States
(12) Patent Application Publication
(10) Pub. No.: US 2025/0322651 A1
(43) Pub. Date: Oct. 16, 2025

(54) DECODER TRAINING METHOD AND APPARATUS, TARGET DETECTION METHOD AND APPARATUS, AND STORAGE MEDIUM

(71) Applicant: JINGDONG TECHNOLOGY INFORMATION TECHNOLOGY CO., LTD., Beijing (CN)

(72) Inventors: Qiong CAO, Beijing (CN); Dingfeng SHI, Beijing (CN); Dacheng TAO, Beijing (CN)

(21) Appl. No.: 18/866,155

(22) PCT Filed: Mar. 16, 2023
(86) PCT No.: PCT/CN2023/081879

§ 371 Date: Nov. 15, 2024

(30) Foreign Application Priority Data
Jul. 6, 2022 (CN) 202210788886.5

(51) Int. Cl. G06V 10/776; G06V 10/44; G06V 10/74; G06V 10/764; G06V 10/766; G06V 10/774; G06V 10/82; G06V 20/40

(52) U.S. Cl. CPC G06V 10/776; G06V 10/443; G06V 10/761; G06V 10/764; G06V 10/766; G06V 10/774; G06V 10/82; G06V 20/46

(57) ABSTRACT

A training method includes generating, by using a relational attention module and on the basis of query features, a salient query feature set corresponding to the query features for performing updating processing; acquiring, by using a cross-attention module and on the basis of updated query features, predicted segment quality information corresponding to the updated query features, and constructing a segment quality loss function; acquiring segment relation features between predicted video segments corresponding to the query features, and constructing a segment relation loss function; and performing adjustment processing according to the segment quality loss function and the segment relation loss function.

### CROSS-REFERENCE TO RELATED APPLICATIONS

The present disclosure is based on and claims the priority to the Chinese application No. 202210788886.5 filed on Jul. 6, 2022, the disclosure of which is incorporated herein in its entirety.

### TECHNICAL FIELD

The present disclosure relates to the technical field of artificial intelligence, and in particular, to a training method and apparatus for a decoder, a target detection method and apparatus, and a storage medium.

### BACKGROUND

As the amount of video data is growing increasingly, demands for analysis and processing of the video data rise increasingly. For example, in scenarios such as live content security detection and short video dangerous action detection, risky actions in the video data need to be identified using a video action detection method. At present, in the action detection, target detection is generally performed using a DETR (Bidirectional Encoder Representations from Transformer) model. The DETR model achieves query-based two-dimensional image target detection by using the Transformer. The Transformer is a network structure based on an Attention mechanism, and constructing a model by the Transformer enables effective improvement in the performance of the video action detection method.

### SUMMARY

According to a first aspect of the present disclosure, there is provided a method for training a decoder, wherein the decoder comprises a relational attention module and a cross-attention module, and the method comprises: generating, by using the relational attention module and on the basis of query features, a salient query feature set corresponding to the query features, to perform, by using the relational attention module and on the basis of the salient query feature set, updating processing on the query features; acquiring, by using the cross-attention module and on the basis of the updated query features, predicted segment quality information corresponding to the updated query features, and constructing a segment quality loss function according to the predicted segment quality information; acquiring segment relation features between predicted video segments corresponding to the query features, and constructing a segment relation loss function; and performing adjustment processing on the relational attention module and the cross-attention module according to the segment quality loss function and the segment relation loss function.

In some embodiments, the generating a salient query feature set corresponding to the query features comprises: acquiring, by using the relational attention module and on the basis of the query features, similarity information between the query features and segment relation feature information between video segments corresponding to the query features; generating a similar feature set corresponding to the query features according to the similarity information; generating a relation feature set corresponding to the query features according to the segment relation feature information; and generating the salient query feature set on the basis of the similar feature set, the relation feature set, and the query features themselves.

In some embodiments, the generating a similar feature set corresponding to the query features according to the similarity information comprises: acquiring similar query features of the query features according to the similarity information, wherein a similarity between the query feature and the similar query feature is greater than a preset similarity threshold; and generating the similar feature set on the basis of the similar query features.

In some embodiments, the segment relation feature information comprises a segment intersection-over-union, and the generating a relation feature set corresponding to the query features according to the segment relation feature information comprises: acquiring relation query features of the query features according to the segment intersection-over-union, wherein the segment intersection-over-union between the query features and the relation query features is greater than a preset intersection-over-union threshold; and generating the relation feature set on the basis of the relation query features.

In some embodiments, the generating the salient query feature set on the basis of the similar feature set, the relation feature set, and the query features themselves comprises: acquiring a relative complementary set of the similar feature set with respect to the relation feature set; and using a union of the relative complementary set and the query features themselves as the salient query feature set.

In some embodiments, the predicted segment quality information comprises predicted segment quality scores, and the acquiring, by using the cross-attention module and on the basis of the updated query features, predicted segment quality information corresponding to the updated query features comprises: determining predicted segments corresponding to the updated query features, and acquiring video segments corresponding to the predicted segments; determining a prediction distance between a midpoint of the predicted segment and a midpoint of the video segment and a prediction intersection-over-union between the predicted segment and the video segment; and generating the predicted segment quality score on the basis of the prediction distance and the prediction intersection-over-union.

In some embodiments, the constructing a segment quality loss function according to the predicted segment quality information comprises: determining a segment distance between the predicted segment midpoint and the video segment midpoint, a segment intersection-over-union between the predicted segment and the video segment; and constructing the segment quality loss function according to information of deviations of the prediction distance and the prediction intersection-over-union with the corresponding segment distance and segment intersection-over-union.

In some embodiments, the segment relation feature comprises a predicted segment intersection-over-union, and the acquiring segment relation features between predicted video segments corresponding to the query features, and constructing a segment relation loss function comprises: determining predicted segment intersection-over-union between the predicted segments corresponding to the updated query features; and constructing the segment relation loss function according to information of accumulation of the predicted segment intersection-over-union.

In some embodiments, the performing, by using the relational attention module and on the basis of the salient query feature set, updating processing on the query features comprises: performing, by using the relational attention module, self-attention calculation processing on the features within the salient query feature set, to perform updating processing on the query features.

In some embodiments, the decoder module comprises: a decoder from Transformer.

According to a second aspect of the present disclosure, there is provided a target detection method, comprising: acquiring a trained decoder, wherein the decoder is trained by the method as described above; generating, by using the decoder and on the basis of query features, a classification confidence, regression information for characterizing a target position, and a predicted segment quality score; and determining a prediction score on the basis of the classification confidence and the predicted segment quality score.

According to a third aspect of the present disclosure, there is provided a training apparatus for a decoder, wherein the decoder comprises: a relational attention module and a cross-attention module; and the training apparatus comprises: a query set acquisition module configured to generate, by using the relational attention module and on the basis of query features, a salient query feature set corresponding to the query features; a query feature updating module configured to perform, by using the relational attention module and on the basis of the salient query feature set, updating processing on the query features; a segment quality determination module configured to acquire, by using the cross-attention module and on the basis of the updated query features, predicted segment quality information corresponding to the updated query features, and construct a segment quality loss function according to the predicted segment quality information; a prediction loss determination module configured to determine acquiring segment relation features between predicted video segments corresponding to the query features and constructing a segment relation loss function; and a module adjustment module configured to perform adjustment processing on the relational attention module and the cross-attention module according to the segment quality loss function and the segment relation loss function.

In some embodiments, the query set acquisition module comprises: a feature information acquisition unit configured to acquire, by using the relational attention module and on the basis of the query features, similarity information between the query features and segment relation feature information between video segments corresponding to the query features; a similar set acquisition unit configured to generate a similar feature set corresponding to the query features according to the similarity information; a relation set acquisition unit configured to generate a relation feature set corresponding to the query features according to the segment relation feature information; and a salient set acquisition unit configured to generate the salient query feature set on the basis of the similar feature set, the relation feature set, and the query features themselves.

In some embodiments, the similarity set acquisition unit is specifically configured to acquire similar query features of the query features according to the similarity information, wherein a similarity between the query feature and the similar query feature is greater than a preset similarity threshold; and generate the similar feature set on the basis of the similar query features.

In some embodiments, the segment relation feature information comprises a segment intersection-over-union, and the relation set acquisition unit is specifically configured to acquire relation query features of the query features according to the segment intersection-over-union, wherein a segment intersection-over-union between the query features and the relation query features is greater than a preset intersection-over-union threshold; and generate the relation feature set on the basis of the relation query features.

In some embodiments, the salient set acquisition unit is specifically configured to acquire a relative complementary set of the similar feature set with respect to the relation feature set; and use a union of the relative complementary set and the query features themselves as the salient query feature set.

In some embodiments, the predicted segment quality information comprises predicted segment quality scores; and the segment quality determination module comprises: a segment quality determination unit configured to determine predicted segments corresponding to the updated query features, and acquire video segments corresponding to the predicted segments; determine a prediction distance between a midpoint of the predicted segment and a midpoint of the video segment and a prediction intersection-over-union between the predicted segment and the video segment; and generate the predicted segment quality score on the basis of the prediction distance and the prediction intersection-over-union.

In some embodiments, the segment quality determination module comprises: a quality loss determination unit configured to determine a segment distance between the predicted segment midpoint and the video segment midpoint and a segment intersection-over-union between the predicted segment and the video segment; and construct the segment quality loss function according to information of deviations of the prediction distance and the prediction intersection-over-union with the corresponding segment distance and segment intersection-over-union.

In some embodiments, the segment relation feature comprises a predicted segment intersection-over-union; and the prediction loss determination module is specifically configured to determine predicted segment intersection-over-union between the predicted segments corresponding to the updated query features; and construct the segment relation loss function according to information of accumulation of the predicted segment intersection-over-union.

In some embodiments, the query feature updating module is specifically configured to perform, by using the relational attention module, self-attention calculation processing on the features within the salient query feature set, to perform updating processing on the query features.

In some embodiments, the decoder module comprises: a decoder from Transformer.

According to a fourth aspect of the present disclosure, there is provided a training apparatus for a decoder, comprising: a memory; and a processor coupled to the memory, the processor being configured to perform, on the basis of instructions stored in the memory, the method as described above.

According to a fifth aspect of the present disclosure, there is provided a target detection apparatus, comprising: a model acquisition module configured to acquire a trained decoder, wherein the decoder is trained by the method as described above; a detection processing module configured to generate, by using the decoder and on the basis of query features, a classification confidence, regression information for characterizing a target position, and a predicted segment quality score; and a prediction score module configured to determine a prediction score on the basis of the classification confidence and the predicted segment quality score.

According to a sixth aspect of the present disclosure, there is provided a target detection apparatus, comprising: a memory; and a processor coupled to the memory, the processor being configured to perform, on the basis of instructions stored in the memory, the method as described above.

According to a seventh aspect of the present disclosure, there is provided a computer-readable storage medium having thereon stored computer instructions which, when executed by a processor, implement the method as described above.

### BRIEF DESCRIPTION OF THE DRAWINGS

In order to more clearly illustrate the embodiments of the present disclosure or technical solutions in the related art, the drawings to be used in the description of the embodiments or the related art will be briefly described below, it is obvious that the drawings in the description below are only some embodiments of the present disclosure, and for one of ordinary skill in the art, other drawings may be obtained according to these drawings without paying creative labor.

FIG. 1 is a schematic flow diagram of a method for training a decoder according to some embodiments of the present disclosure;

FIG. 2 is a schematic structural diagram of a network framework for a decoder according to some embodiments of the present disclosure;

FIG. 3 is a schematic flow diagram of generating a salient query feature set in a method for training a decoder according to some embodiments of the present disclosure;

FIG. 4 is a schematic diagram of a relation between query features;

FIG. 5 is a schematic flow diagram of generating a predicted segment quality score in a method for training a decoder according to some embodiments of the present disclosure;

FIG. 6 is a schematic diagram of processing query features in a method for training a decoder according to some embodiments of the present disclosure;

FIG. 7 is a schematic flow diagram of constructing a segment quality loss function in a method for training a decoder according to some embodiments of the present disclosure;

FIG. 8 is a schematic flow diagram of constructing a segment relation loss function in a method for training a decoder according to some embodiments of the present disclosure;

FIG. 9 is a schematic flow diagram of a target detection method according to some embodiments of the present disclosure;

FIG. 10 is a schematic block diagram of a training apparatus for a decoder according to some embodiments of the present disclosure;

FIG. 11 is a schematic block diagram of a query set acquisition module in a training apparatus for a decoder according to some embodiments of the present disclosure;

FIG. 12 is a schematic block diagram of a segment quality determination module in a training apparatus for a decoder according to some embodiments of the present disclosure;

FIG. 13 is a schematic block diagram of a training apparatus for a decoder according to other embodiments of the present disclosure;

FIG. 14 is a schematic block diagram of a target detection apparatus according to some embodiments of the present disclosure;

FIG. 15 is a schematic block diagram of a target detection apparatus according to other embodiments of the present disclosure.

### DETAILED DESCRIPTION

A more comprehensive description of the present disclosure with reference to the accompanying drawings will be made below, in which exemplary embodiments of the present disclosure are illustrated. The technical solutions in the embodiments of the present disclosure will be described clearly and completely in conjunction with the drawings in the embodiments of the present disclosure, and it is obvious that the embodiments described are only some embodiments of the present disclosure, rather than all embodiments. All other embodiments which are obtained based on the embodiments in the present disclosure, by one of ordinary skill in the art without making creative labor, shall fall within the scope of protection of the present disclosure. The technical solutions of the present disclosure are variously described below in conjunction with various figures and embodiments.

In the related art known to the inventors, a DETR model includes an encoder and decoder from Transformer, i.e., a Transformer encoder and a Transformer decoder. An original video sequence passes through a backbone network (such as a convolutional neural network) to extract temporal and spatial feature maps, and the feature maps plus positional encoding information are synthesized into an embedding vector for inputting into the Transformer encoder. The Transformer encoder extracts image encoding features by a self-attention mechanism, and inputs the image encoding features and query features into the Transformer decoder. The Transformer decoder outputs target query vectors, the target query vectors pass through a classification head and a regression head constructed by a fully connected layer and a multi-layer perceptron layer to output a position and category of a detected target, wherein the detected target can be walking, running and other actions.

The Transformer has better performance in feature representation, so that constructing a model by the Transformer enables effective improvement in performance of a video action detection method. The Transformer encoder contains a plurality of encoder layers, the related encoder layer being formed by one multi-head self-attention layer, two normalization layers, and one feedforward neural network layer. The related Transformer decoder contains a plurality of decoder layers, the decoder layer being formed by two multi-head self-attention layers, three normalization layers, and one feedforward neural network layer.

In the DETR method, by taking a fixed number N of learnable query features as inputs, each query feature adaptively samples pixel points from a two-dimensional image over the network, and information interaction between the query features is performed in a manner of self-attention, and finally, each query feature is used for independently predicting a position and category of one detection box. In the field of temporal action detection, a fixed number of detected targets are predicted in a manner of encoder-decoder. When the target is detected, temporal segment features are extracted by using sparse sampling-based Transformer.

For the decoder part, K trainable query features are taken as inputs. The query feature, which is a learnable vector, can extract temporal features from a specific time instant according to learned statistical information. The information interaction between all the query features is realized by using the self-attention operation, wherein each query feature may predict normalized coordinates of k sampled points on N time dimensions through one fully connected layer, and extract features from video features according to the sampled points to update the query features. For example, through another fully connected layer, the query features are input to predict k weights, and the sampled k features are weighted and summed. The updated query features predict a position and type of an action through the regression head and the classification head, respectively. The regression head and the classification head are three fully connected layers and one fully connected layer, respectively, the regression head predicting normalized coordinates of start and end of the action, and the classification head predicting a classification and confidence score of the action.

The related decoder in the DETR model usually adopts a dense self-attention mechanism to acquire a correlation between the query features, without considering a semantic relation between video segments corresponding to each query feature, so that an invalid query segment can interfere with a result predicted for each query feature, and due to lack of a constraint between the query features, it easily leads to redundant predicted results, resulting in inaccurate prediction scores.

In the process of implementing the present disclosure, the inventors have found that the DETR model predicts a fixed number of detected targets in a manner of encoder-decoder, and the decoder usually adopts a dense self-attention mechanism to determine the correlation between query features, without considering a semantic relation between video segments s corresponding to each query feature, so that an invalid query feature can interfere with a result predicted for the query feature, and the prediction result is inaccurate for the prediction of the query feature.

In view of this, a technical problem to be solved by the present disclosure is to provide a training method and apparatus for a decoder, a target detection method and apparatus, and a storage medium, where constructing a salient query feature set according to relations between query features, and performing self-attention processing on the query features within the salient query feature set, can reduce the interference of the invalid query feature with the prediction; acquiring newly added predicted segment quality information and constructing a segment quality loss function, can inhibit redundant predicted results and improve the accuracy of the detection results; constructing a segment relation loss function can inhibit redundant prediction, causing the prediction results to be more accurate.

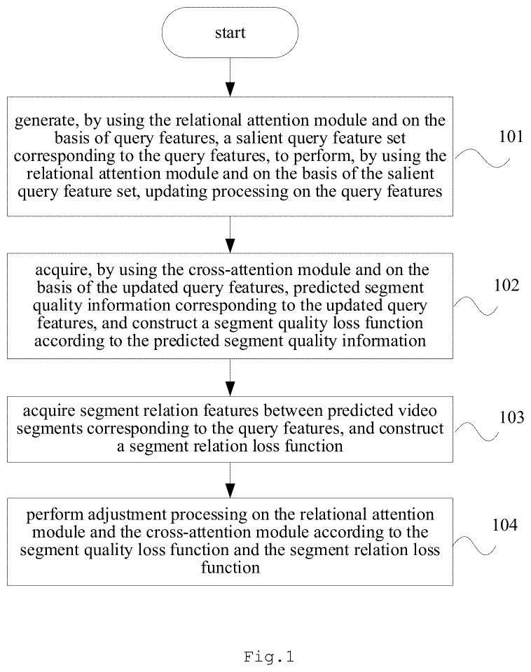

FIG. 1 is a schematic flow diagram of a method for training a decoder according to some embodiments of the present disclosure, wherein the decoder comprises a relational attention module and a cross-attention module, as shown in FIG. 1:

Step 101, generating, by using the relational attention module and on the basis of query features, a salient query feature set corresponding to the query features, to perform, by using the relational attention module and on the basis of the salient query feature set, updating processing on the query features.

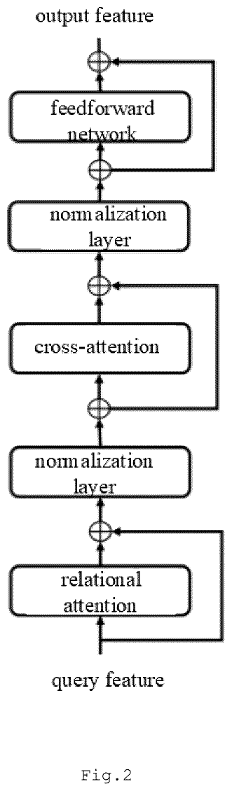

In some embodiments, the query feature may be a query vector generated by an existing Transformer encoder, etc. The decoder module comprises a decoder from Transformer, namely a Transformer decoder. As shown in FIG. 2, the Transformer decoder includes a relational attention module, a cross-attention module, two normalization layers, and a feedforward network. The normalization layer and the feedforward network can use existing various implementations. Inputs of the Transformer decoder are a fixed number of trainable query features. The relational attention module is a module after optimizing a self-attention module in an existing Transformer decoder, for performing non-dense attention processing on the query features.

Step 102, acquiring, by using the cross-attention module and on the basis of the updated query features, predicted segment quality information corresponding to the updated query features, and constructing a segment quality loss function according to the predicted segment quality information.

In some embodiments, by using the cross-attention module and on the basis of the updated query features, a classification confidence, regression information for characterizing a target position and a predicted segment quality score are generated through a feedforward network as well as a classification head, a regression head, and a segment quality head, wherein the target is an action in a video, etc., the classification confidence may be a score for the classification confidence, and the regression information may be information of start and end of the action.

The cross-attention module is a module after optimizing a self-attention module in an existing Transformer decoder. The segment quality head is added to obtain the predicted segment quality score, and in prediction, the predicted segment quality score and the classification confidence score are multiplied to obtain a final prediction score of the query feature.

Step 103, acquiring segment relation features between predicted video segments corresponding to the query features, and constructing a segment relation loss function.

Step 104, performing adjustment processing on the relational attention module and the cross-attention module according to the segment quality loss function and the segment relation loss function.

In some embodiments, parameters of the modules, such as the relational attention module and the cross-attention module may be adjusted by using existing various model adjustment methods according to the segment quality loss function and the segment relation loss function, so that a function value of the segment quality loss function and a function value of the segment relation loss function are within allowed value ranges, respectively.

In some embodiments, the salient query feature set corresponding to the query features may be generated by using various methods. FIG. 3 is a schematic flow diagram of generating a salient query feature set in a method for training a decoder according to some embodiments of the present disclosure, as shown in FIG. 3:

Step 301, acquiring, by using the relational attention module and on the basis of the query features, similarity information between the query features and segment relation feature information between video segments corresponding to the query features.

In some embodiments, the similarity information between the query features may be calculated by using existing various methods, wherein the similarity information may be a cosine similarity, etc. The segment relation feature information between the video segments corresponding to the query features may be calculated by using existing various methods, the segment relation feature information comprising a segment intersection-over-union, etc.

Step 302, generating a similar feature set corresponding to the query features according to the similarity information.

In some embodiments, similar query features of the query features are acquired according to the similarity information, wherein a similarity between the query feature and the similar query feature is greater than a preset similarity threshold, and the similarity may be a cosine similarity or the like. A similar feature set is generated on the basis of the similar query features.

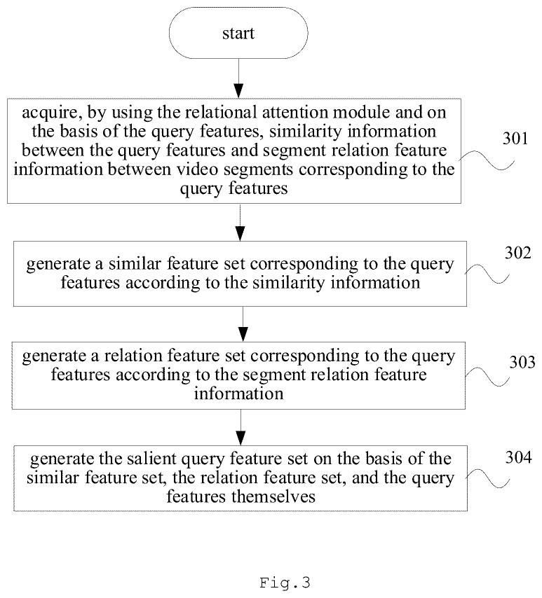

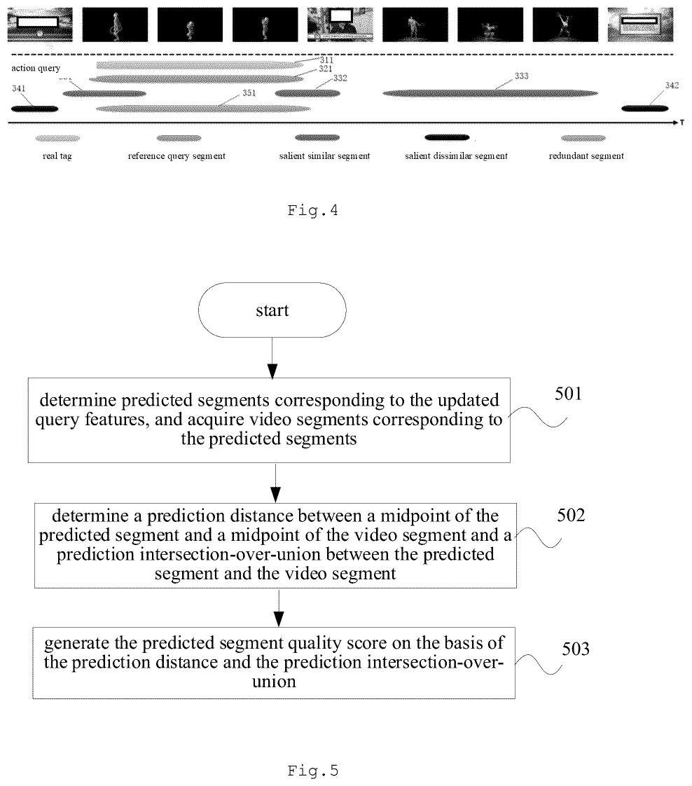

A relation between the query features is modeled, for example, by the relational attention module. In FIG. 4, query features include a real tag 311, a reference query segment 321, salient similar segments 331, 332, 333, salient dissimilar segments 341,342, a redundant segment 351, etc. After entering the relational attention module, each query feature predicts a corresponding temporal segment through a fully connected layer. For the reference query segment 321, a corresponding salient query feature set includes the salient similar segments 331, 332, 333, etc., and query features in a similar feature set have features such as semantic similarity, non-redundancy in a time dimension.

According to the similarity information between the query features, a similarity matrix A∈R^{L}^{_{q}}^{×L}^{_{q}} is constructed, wherein Lq is a fixed number of the query features, A is a similarity matrix for characterizing a similarity between every two of the Lq query features, and each element in the similarity matrix A is a cosine similarity between two query features. On the basis of the similarity threshold γ∈[−1, 1], the similar feature set is constructed by:

$${E}_{s i m} = \{ ( i , j ) \vert A [ i , j ] - γ > 0 \} ; \qquad ( 1 - 1 )$$

where A[i,j] is a similarity between an i-th query feature and a j-th query feature, γ is a pre-defined similarity threshold before training, and Eₛᵢₘ is a similar feature set constructed according to the similarity between the features, and can correspond to the query features, so that there are a plurality of Eₛᵢₘ.

Step 303, generating a relation feature set corresponding to the query features according to the segment relation feature information.

In some embodiments, the segment relation feature information is a segment intersection-over-union (IoU for short), and the like. Relation query features of the query features are acquired according to the segment intersection-over-union, wherein the segment intersection-over-union between the query features and the relation query features is greater than a preset intersection-over-union threshold. The relation feature set is generated on the basis of the relation query features.

For example, the intersection-over-union (IoU) is used for characterizing the length of an intersection between two segments/the length of a union of the two segments. On the basis of the segment intersection-over-union, an IoU matrix is constructed by: B∈R^{L}^{_{q}}^{×L}^{_{q}}, where each element in the B matrix is an IoU value between video segments (which may be reference feature segments) corresponding to two query features. According to the intersection-over-union threshold τ∈[0,1], the relation feature set is constructed by:

$${E}_{I o U} = \{ ( i , j ) \vert B [ i , j ] - τ > 0 \} ; \qquad ( 1 - 2 )$$

where E_{IoU} is the relation feature set constructed according to an IoU relation; B[i,j] is an IoU relation between the i-th query feature and the j-th query feature, namely B[i,j] is an IoU value between video segments corresponding to the i-th query feature and the j-th query feature; and τ is a pre-defined intersection-over-union threshold before training.

Step 304, generating the salient query feature set on the basis of the similar feature set, the relation feature set, and the query features themselves.

In some embodiments, a relative complementary set of the similar feature set with respect to the relation feature set is acquired, and a union of the relative complementary set and the query features themselves is used as the salient query feature set.

For example, the salient query feature set is constructed by:

$$E = ( {E}_{I o U} ∖ {E}_{s i m} ) ⋃ {E}_{s e l f} ; \qquad ( 1 - 3 )$$

where E is the salient query feature set, and E_{self}, which is a self-connection set, represents a connection between the i-th query feature and itself.

In some embodiments, self-attention calculation processing is performed on the features within the salient query feature set by using the relational attention module, to perform updating processing on the query features. An existing self-attention calculation g method may be used to perform self-attention calculation processing on the features within the salient query feature set, and more expressive features can be obtained on the basis of the existing query features by means of the self-attention calculation processing.

For example, attention weights are calculated for query features within the salient query feature set by:

$${q}_{i}^{′} = {a}_{i} {V}_{i}^{T} ; \qquad ( 1 - 4 )$$

$${a}_{i} = {Softmax}_{K} ( {q}_{i} {K}_{i}^{T} ) ; \qquad ( 1 - 5 )$$

where Q, K, V are Query, Key and Value features of each query feature, respectively, Ki and Vi are Key and Value sets within the salient query feature set corresponding to the i-th query feature, q′ᵢ is a query feature after the i-th Query feature is updated, aᵢ is an attention weight of an element within the salient query feature set, which is a row normalization matrix, and is a value of weighted summation of each feature in the Value set.

In order to eliminate interference of an invalid query feature segment with the prediction, in the method for training a decoder of the present disclosure, a salient query feature set is dynamically constructed for each query feature on the basis of two indexes: the feature similarity and the IoU, in place of a dense attention operation for self-attention, so that attention is calculated only by this query feature and other query features within the salient query feature set.

In some embodiments, the predicted segment quality information corresponding to the updated query features may be acquired by using various methods. FIG. 5 is a schematic flow diagram of generating a predicted segment quality score in a method for training a decoder according to some embodiments of the present disclosure, wherein the predicted segment quality information comprises predicted segment quality scores, as shown in FIG. 5:

Step 501, determining predicted segments corresponding to the updated query features, acquiring video segments corresponding to the predicted segments.

Step 502, determining a prediction distance between a midpoint of the predicted segment and a midpoint of the video segment and a prediction intersection-over-union between the predicted segment and the video segment.

Step 503, generating a predicted segment quality score on the basis of the prediction distance and the prediction intersection-over-union.

The segment quality loss function may be constructed according to the predicted segment quality information by using various methods. FIG. 7 is a schematic flow diagram of constructing a segment quality loss function in a method for training a decoder according to some embodiments of the present disclosure, as shown in FIG. 7:

Step 701, determining a segment distance between the predicted segment midpoint and the video segment midpoint, and a segment intersection-over-union between the predicted segment and the video segment.

Step 702, constructing the segment quality loss function according to information of deviations of the prediction distance and the prediction intersection-over-union with the corresponding segment distance and segment intersection-over-union.

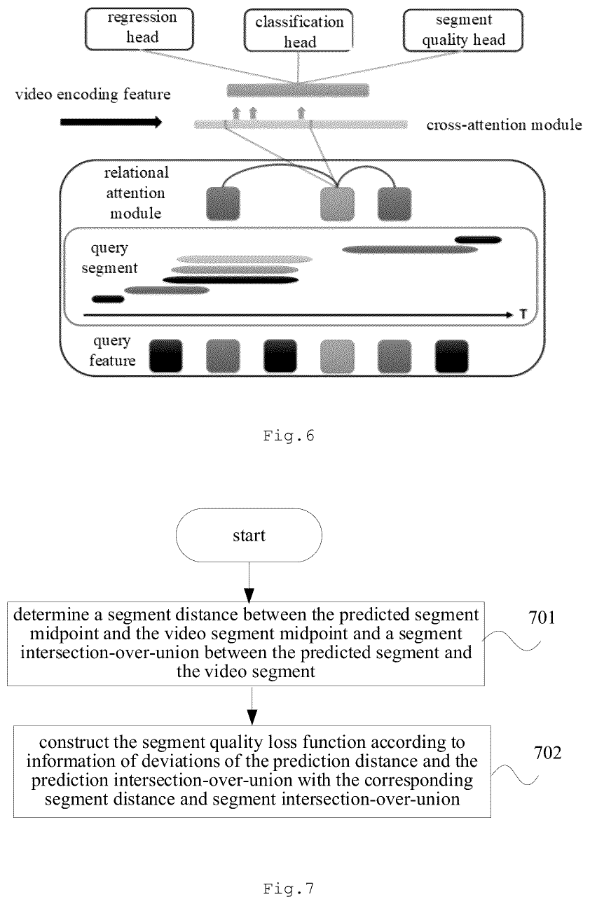

For example, as shown in FIG. 6, the query features updated by the relational attention module are input into the cross-attention module, which predicts sampled points in a time dimension, and obtains features of video segments by weighting and summing the sampled features, and the features of the video segments are sent into detection heads through a feedforward network. In addition to existing regression and classification heads, a segment quality head is added to estimate the quality of the segment.

The predicted segment s_{q} corresponding to the updated query feature and the updated query feature f_{g} corresponding to s_{q} are determined. It is defined (ζ₁, ζ₂)=(f_{q}), characterizing that two values, ζ₁ and ζ₂, are predicted by a fully connected layer, where ϕ( ) is a function of a single-layer fully connected layer and may be a plurality of functions, ζ₁ is the prediction distance between the midpoint of the predicted segment and the midpoint of the video segment (action segment), and ζ₂ is the prediction intersection-over-union between the predicted segment and the video segment (action segment). The predicted segment quality score is defined as ζ=ζ₁·ζ₂. In training, by using an offset between the midpoint of the predicted segment and the midpoint of its corresponding action segment and the intersection-over-union (IoU) value therebetween, the segment quality loss function is constructed by:

$${L}_{ζ} = \sum {\vert ϕ ( {f}_{q} ) - ( exp ( - \frac{1}{{l}_{g t}} \vert {m}_{q} - {m}_{g t} \vert ) , IoU ( {s}_{q} , {s}_{g t} ) ) \vert}_{1} ; \qquad ( 1 - 6 )$$

where

$$exp ( - \frac{1}{{l}_{g t}} \vert {m}_{q} - {m}_{g t} \vert )$$

is a distance between midpoints of the predicted segment and a nearest Ground truth, i.e., an actual segment distance between the midpoint m_{q} of the predicted segment and the midpoint m_{gt} of the corresponding video segment (a segment nearest to the predicted segment); and IOU (s_{q}, s_{gt}) is an IoU between the predicted segment and the nearest Ground truth, i.e., an actual segment intersection-over-union between the predicted segment s_{q} and the corresponding video segment s_{gt}.

In prediction, a classification execution score output by the classification head and ζ are multiplied to obtain a final score of the predicted segment for each query feature. By adding the segment quality head, the product of the offset degree and the coincidence degree between the predicted segment and the real action is used as the quality score, to jointly determine the predicted segment score in the prediction, improving the accuracy of the detection result.

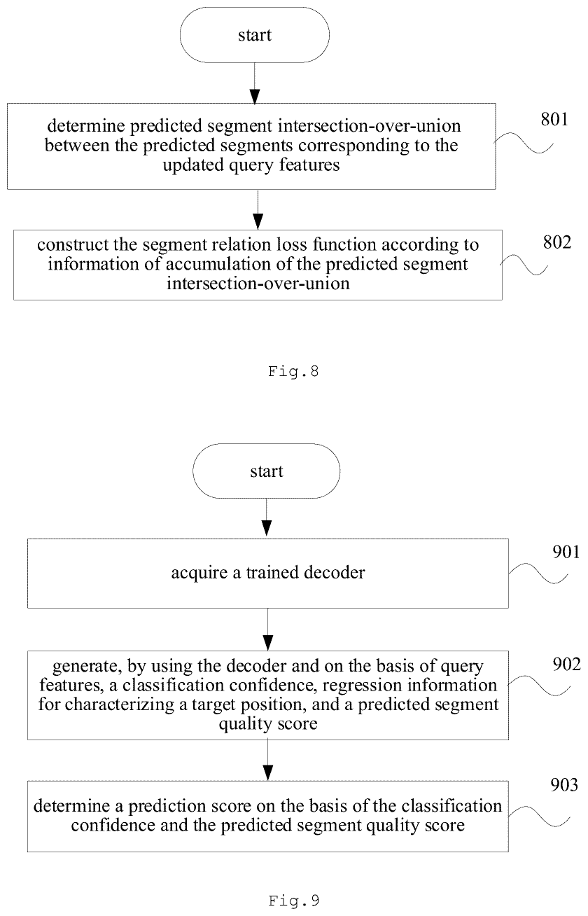

The segment relation loss function may be constructed by using various methods. FIG. 8 is a schematic flow diagram of constructing a segment relation loss function in a method for training a decoder according to some embodiments of the present disclosure, wherein the segment relation feature comprises a predicted segment intersection-over-union, as shown in FIG. 8:

Step 801, determining predicted segment intersection-over-union between the predicted segments corresponding to the updated query features.

Step 802, constructing the segment relation loss function according to information of accumulation of the predicted segment intersection-over-union.

In some embodiments, in the training phase, by introducing the IoU constraint item, the segment relation loss function is constructed by:

$${ω}_{d} = \frac{1}{2} {\sum }_{i = 1}^{{L}_{q}} {\sum }_{j = 1}^{{L}_{q}} I o U ( {s}_{i} , {s}_{j} ) ; \qquad ( 1 - 7 )$$

where Lq is the number of the query features, si and sj are the predicted segments corresponding to the i-th and j-th query features, which are prediction-number outputs from a previous-layer regression head; and the IoU is an IoU (Intersection-over-union) relation between the two segments, si and sj, calculated by

$$I o U ( {s}_{i} , {s}_{j} ) = \frac{{s}_{i} ⋃ {s}_{j}}{{s}_{i} ⋂ {s}_{j}} ; \qquad ( 1 - 8 )$$

and by constructing the segment relation loss function, redundant query prediction can be inhibited, thereby increasing the probability of obtaining a more accurate prediction result.

FIG. 9 is a schematic flow diagram of a target detection method according to some embodiments of the present disclosure, as shown in FIG. 9:

Step 901, acquiring a trained decoder, wherein the decoder is trained by the training method as described above.

Step 902, generating, by using the decoder and on the basis of query features, a classification confidence, regression information for characterizing a target position, and a predicted segment quality score.

In some embodiments, the decoder module comprises a Transformer decoder, which includes a relational attention module, a cross-attention module, two normalization layers, and a feedforward network. Inputs of the Transformer decoder are a fixed number of trainable query features. The relational attention module performs non-dense attention processing on the query features, and by using the cross-attention module and on the basis of updated query features, the classification confidence, the regression information for characterizing the target position, and the predicted segment quality score are generated through a feedforward network as well as a classification head, a regression head, and a segment quality head.

Step 903, determining a prediction score on the basis of the classification confidence and the predicted segment quality score.

In some embodiments, the predicted segment quality score and a score for the classification confidence are multiplied to determine a final prediction score for each query feature.

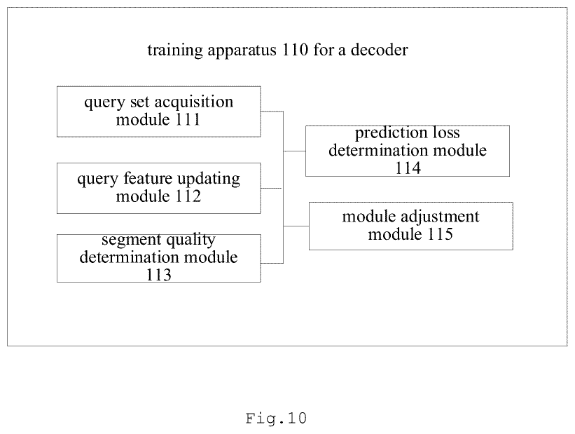

In some embodiments, as shown in FIG. 10, the present disclosure provides a training apparatus 110 for a decoder, wherein the decoder comprises a relational attention module and a cross-attention module, etc.; and the training apparatus 110 for a decoder comprising a query set acquisition module 111, a query feature updating module 112, a segment quality determination module 113, a prediction loss determination module 114, and a module adjustment module 115.

The query set acquisition module 111 generates, by using the relational attention module and on the basis of query features, a salient query feature set corresponding to the query features. The query feature update module 112 performs, by using the relational attention module and on the basis of the salient query feature set, updating processing on the query features. For example, the query feature update module 112 performs, by using the relational attention module, self-attention calculation processing on features within the salient query feature set, to perform updating processing on the query features.

The segment quality determination module 113 acquires, by using the cross-attention module and on the basis of the updated query features, predicted segment quality information corresponding to the updated query features, and constructs a segment quality loss function according to the predicted segment quality information. The prediction loss determination module 114 determines acquiring segment relation features between predicted video segments corresponding to the query features and constructing a segment relation loss function. The module adjustment module 115 performs adjustment processing on the relational attention module and the cross-attention module according to the segment quality loss function and the segment relation loss function.

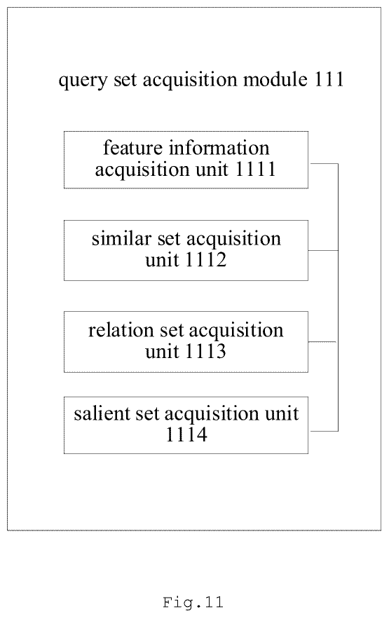

In some embodiments, as shown in FIG. 11, the query set acquisition module 111 comprises a feature information acquisition unit 1111, a similar set acquisition unit 1112, a relation set acquisition unit 1113, and a salient set acquisition unit 1114. The feature information acquisition unit 1111 acquires, by using the relational attention module and on the basis of the query features, similarity information between the query features and segment relation feature information between video segments corresponding to the query features.

The similar set acquisition unit 1112 generates a similar feature set corresponding to the query features according to the similarity information. The relation set acquisition unit 1113 generates a relation feature set corresponding to the query features according to the segment relation feature information. The salient set acquisition unit 1114 generates the salient query feature set on the basis of the similar feature set, the relation feature set, and the query features themselves.

In some embodiments, the similar set acquisition unit 1112 acquires similar query features of the query features according to the similarity information, wherein a similarity between the query feature and the similar query feature is greater than a preset similarity threshold. The similar set acquisition unit 1112 generates the similar feature set on the basis of the similar query features.

The segment relation feature information comprises a segment intersection-over-union and the like, and the relation set acquisition unit 1113 acquires relation query features of the query features according to the segment intersection-over-union, wherein a segment intersection-over-union between the query features and the relation query features is greater than a preset intersection-over-union threshold. The relation set acquisition unit 1113 generates the relation feature set on the basis of the relation query features.

The salient set acquisition unit 1114 acquires a relative complementary set of the similar feature set with respect to the relation feature set. The salient set acquisition unit 1114 uses a union of the relative complementary set and the query features themselves as the salient query feature set.

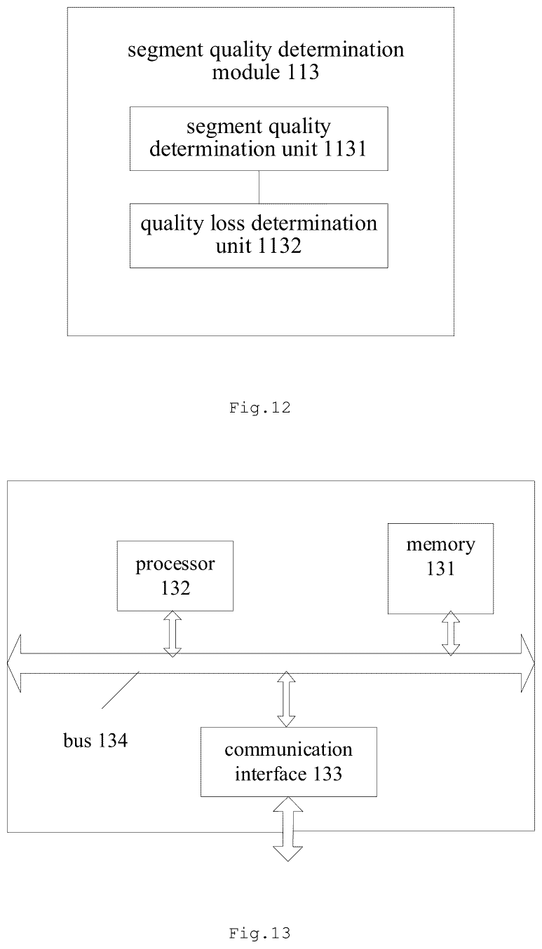

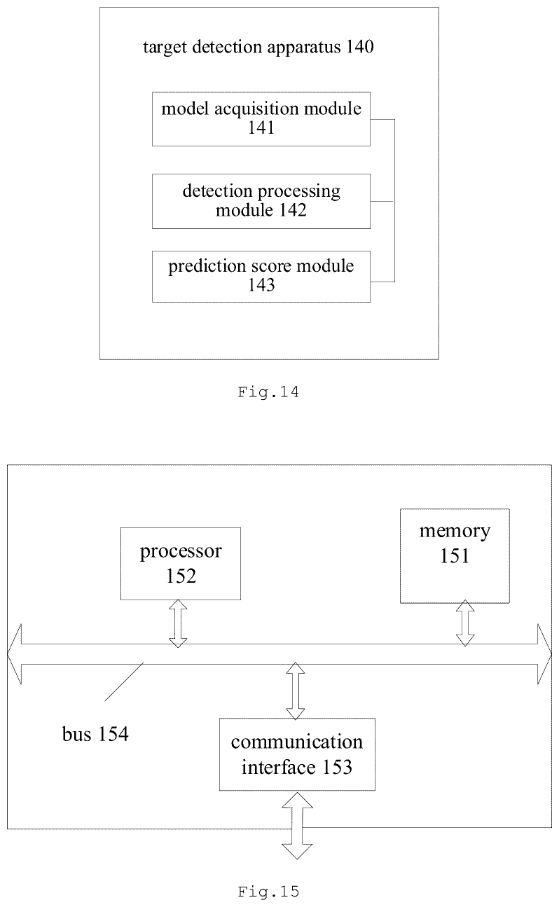

In some embodiments, the predicted segment quality information comprises predicted segment quality scores; and as shown in FIG. 12, the segment quality determination module 113 comprises a segment quality determination unit 1131 and a quality loss determination unit 1132. The segment quality determination unit 1131 determines predicted segments corresponding to the updated query features, and acquires video segments corresponding to the predicted segments; the segment quality determination unit 1131 determines a prediction distance between a midpoint of the predicted segment and a midpoint of the video segment and a prediction intersection-over-union between the predicted segment and the video segment; and the segment quality determination unit 1131 generates the predicted segment quality score on the basis of the prediction distance and the prediction intersection-over-union.

The quality loss determination unit 1132 determines a segment distance between the predicted segment midpoint and the video segment midpoint and a segment intersection-over-union between the predicted segment and the video segment. The quality loss determination unit 1132 constructs the segment quality loss function according to information of deviations of the prediction distance and the prediction intersection-over-union with the corresponding segment distance and segment intersection-over-union.

In some embodiments, the segment relation feature comprises a predicted segment intersection-over-union, etc., and the prediction loss determination module 114 is configured to determine predicted segment intersection-over-union between the predicted segments corresponding to the updated query features. The prediction loss determination module 114 constructs the segment relation loss function according to information of accumulation of the predicted segment intersection-over-union.

In some embodiments, as shown in FIG. 13, the present disclosure provides a training apparatus for a decoder, which may comprise a memory 131, a processor 132, a communication interface 133, and a bus 134. The memory 131 is used for storing instructions, and the processor 132, which is coupled to the memory 131, is configured to implement, on the basis of the instructions stored in the memory 131, the method for training a decoder as described above.

The memory 131 may be a high-speed RAM memory, a non-volatile memory, or the like, and the memory 131 may also be a memory array. The memory 131 may also be partitioned into blocks and the blocks may be combined into virtual volumes according to certain rules. The processor 132 may be a central processing unit (CPU), or an application specific integrated circuit (ASIC), or one or more integrated circuits configured to implement the method for training a decoder of the present disclosure.

In some embodiments, the present disclosure provides a target detection apparatus 140, comprising a model acquisition module 141, a detection processing module 142, and a prediction score module 143. The model acquisition module 141 acquires a trained decoder, wherein the decoder is trained by the training method as described above.

The detection processing module 142 generates, by using the decoder and on the basis of query features, a classification confidence, regression information for characterizing a target position, and a predicted segment quality score. The prediction score module 143 determines a prediction score on the basis of the classification confidence and the predicted segment quality score.

In some embodiments, as shown in FIG. 15, the present disclosure provides a target detection n apparatus, which may comprise a memory 151, a processor 152, a communication interface 153, and a bus 154. The memory 151 is used for storing instructions, the processor 152, which is coupled to the memory 151, is configured to implement, on the basis of the instructions stored in the memory 151, the target detection method as described above.

The memory 151 may be a high-speed RAM memory, a non-volatile memory, or the like, and the memory 151 may also be a memory array. The memory 151 may also be partitioned into blocks, and the blocks may be combined into virtual volumes according to certain rules. The processor 152 may be a central processing unit (CPU), or an application specific integrated circuit (ASIC), or one or more integrated circuits configured to implement the target detection method of the present disclosure.

In some embodiments, the present disclosure provides a computer-readable storage medium having thereon stored computer instructions which, when executed by a processor, implement the method in any of the above embodiments.

The computer-readable storage medium may take any combination of one or more readable media. The readable medium may be a readable signal medium or a readable storage medium. The readable storage medium may include, for example, but is not limited to, an electronic, magnetic, optical, electromagnetic, infrared, or semiconductor system, apparatus, or device, or a combination of any of the foregoing. More specific examples (non-exhaustively listed) of the readable storage medium may include: an electrical connection having one or more wires, a portable diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

According to the training method and apparatus for a decoder, the target detection method and apparatus, and the storage medium in the above embodiments, constructing a salient query feature set according to relations between query features, and performing self-attention processing on the query features within the salient query feature set, can reduce interference of an invalid query feature with the prediction; acquiring newly added predicted segment quality information and constructing a segment quality loss function, can inhibit redundant predicted results and improve the accuracy of detection results; and constructing a segment relation loss function can inhibit redundant prediction, causing the predicted results to be more accurate, and improving use experience of users.

The basic principles of the present disclosure have been described above in conjunction with specific embodiments, but it needs to be noted that the advantages, benefits, effects, and the like, mentioned in the present disclosure are only examples rather than limitations, so that it cannot be considered that these advantages, benefits, effects, and the like are ones which the embodiments of the present disclosure must have. It should be understood by those skilled in the art that the embodiments of the present disclosure may be provided as a method, system, or computer program product. Accordingly, the present disclosure may take a form of an entire hardware embodiment, an entire software embodiment, or an embodiment combining software and hardware aspects. Furthermore, the present disclosure may take a form of a computer program product implemented on one or more computer-usable non-transitory storage media (including, but not limited to, a disk memory, CD-ROM, optical memory, etc.) having computer-usable program code embodied therein.

The present disclosure has been described with reference to flow diagrams and/or block diagrams of the method, apparatus (system) and computer program product according to the embodiments of the present disclosure. It should be understood that each flow and/or block of the flow diagrams and/or block diagrams, and a combination of flows and/or blocks in the flow diagrams and/or block diagrams, can be implemented by computer program instructions. These computer program instructions may be provided to a processor of a general-purpose computer, special-purpose computer, embedded processor, or other programmable data processing apparatuses to produce a machine, such that the instructions which are executed through the processor of the computer or other programmable data processing apparatuses create means for implementing the functions specified in one or more flows of the flow diagrams and/or one or more blocks of the block diagrams.

These computer program instructions may also be stored in a computer-readable memory that can guide a computer or other programmable data processing apparatuses to work in a specific manner, such that the instructions stored in the computer-readable memory produce an article of manufacture including instruction means which implement the functions specified in one or more flows of the flow diagrams and/or one or more blocks of the block diagrams.

The method and system of the present disclosure may be implemented in a number of ways. The method and system of the present disclosure may be implemented, for example, by software, hardware, firmware, or any combination of software, hardware, and firmware. The above order for the steps of the method is for illustration only, and the steps of the method of the present disclosure are not limited to the order specifically described above unless specifically stated otherwise. Furthermore, in some embodiments, the present disclosure may further be implemented as programs recorded in a recording medium, the programs including machine-readable instructions for implementing the method according to the present disclosure. Therefore, the present disclosure further covers a recording medium storing a program for performing the method according to the present disclosure.

The description of the present disclosure has been presented for purposes of examples and description, and is not intended to be exhaustive or limit this disclosure to the disclosed form. Many modifications and variations are apparent to one of ordinary skill in the art. The selection and description of the embodiments are to better explain the principles and the practical applications of the present disclosure, and to enable one of ordinary skill in the art to understand the present disclosure and therefore design various embodiments with various modifications suitable for a specific purpose.

1. A method for training a decoder, wherein the decoder comprises a relational attention module and a cross-attention module, and the method comprises:
generating, by using the relational attention module and on the basis of query features, a salient query feature set corresponding to the query features, to perform, by using the relational attention module and on the basis of the salient query feature set, updating processing on the query features;
acquiring, by using the cross-attention module and on the basis of the updated query features, predicted segment quality information corresponding to the updated query features, and constructing a segment quality loss function according to the predicted segment quality information;
acquiring segment relation features between predicted video segments corresponding to the query features, and constructing a segment relation loss function; and
performing adjustment processing on the relational attention module and the cross-attention module according to the segment quality loss function and the segment relation loss function.

2. The method of claim 1, wherein the generating a salient query feature set corresponding to the query features comprises:
acquiring, by using the relational attention module and on the basis of the query features, similarity information between the query features and segment relation feature information between video segments corresponding to the query features;
generating a similar feature set corresponding to the query features according to the similarity information;
generating a relation feature set corresponding to the query features according to the segment relation feature information; and
generating the salient query feature set on the basis of the similar feature set, the relation feature set, and the query features.

3. The method of claim 2, wherein the generating a similar feature set corresponding to the query features according to the similarity information comprises:
acquiring similar query features of the query features according to the similarity information, wherein a similarity between the query feature and the similar query feature is greater than a preset similarity threshold; and
generating the similar feature set on the basis of the similar query features.

4. The method of claim 2, wherein the segment relation feature information comprises a segment intersection-over-union, and the generating a relation feature set corresponding to the query features according to the segment relation feature information comprises:
acquiring relation query features of the query features according to the segment intersection-over-union, wherein the segment intersection-over-union between the query features and the relation query features is greater than a preset intersection-over-union threshold; and
generating the relation feature set on the basis of the relation query features.

5. The method of claim 2, wherein the generating the salient query feature set on the basis of the similar feature set, the relation feature set, and the query features comprises:
acquiring a relative complementary set of the similar feature set with respect to the relation feature set; and
using a union of the relative complementary set and the query features as the salient query feature set.

6. The method of claim 1, wherein the predicted segment quality information comprises predicted segment quality scores, and the acquiring, by using the cross-attention module and on the basis of the updated query features, predicted segment quality information corresponding to the updated query features comprises:
determining predicted segments corresponding to the updated query features, and acquiring video segments corresponding to the predicted segments;
determining a prediction distance between a midpoint of the predicted segment and a midpoint of the video segment and a prediction intersection-over-union between the predicted segment and the video segment; and
generating the predicted segment quality score on the basis of the prediction distance and the prediction intersection-over-union.

7. The method of claim 6, wherein the constructing a segment quality loss function according to the predicted segment quality information comprises:
determining a segment distance between the predicted segment midpoint and the video segment midpoint, a segment intersection-over-union between the predicted segment and the video segment; and
constructing the segment quality loss function according to information of deviations of the prediction distance and the prediction intersection-over-union with the corresponding segment distance and segment intersection-over-union.

8. The method of claim 1, wherein the segment relation feature comprises a predicted segment intersection-over-union, and the acquiring segment relation features between predicted video segments corresponding to the query features, and constructing a segment relation loss function comprises:
determining predicted segment intersection-over-union between the predicted segments corresponding to the updated query features; and
constructing the segment relation loss function according to information of accumulation of the predicted segment intersection-over-union.

9. The method of claim 1, wherein the performing, by using the relational attention module and on the basis of the salient query feature set, updating processing on the query features comprises:
performing, by using the relational attention module, self-attention calculation processing on the features within the salient query feature set, to perform updating processing on the query features.

10. The method of claim 1, wherein the decoder module comprises a decoder from Transformer.

11. A target detection method, comprising:
acquiring a trained decoder, wherein the decoder is trained by the method of claim 1;
generating, by using the decoder and on the basis of query features, a classification confidence, regression information for characterizing a target position, and a predicted segment quality score; and
determining a prediction score on the basis of the classification confidence and the predicted segment quality score.

12. (canceled)

13. A training apparatus for a decoder, comprising:
a processor and a memory coupled to the processor, storing program instructions which, when executed by the processor, cause the processor to:
generate, by using the relational attention module and on the basis of query features, a salient query feature set corresponding to the query features, to perform, by using the relational attention module and on the basis of the salient query feature set, updating processing on the query features;
acquire, by using the cross-attention module and on the basis of the updated query features, predicted segment quality information corresponding to the updated query features, and construct a segment quality loss function according to the predicted segment quality information;
acquire segment relation features between predicted video segments corresponding to the query features, and construct a segment relation loss function; and
perform adjustment processing on the relational attention module and the cross-attention module according to the segment quality loss function and the segment relation loss function.

14. (canceled)

15. A target detection apparatus, comprising:
a processor; and
a memory coupled to the processor, storing program instructions which, when executed by the processor, cause the processor to:
acquire a trained decoder, wherein the decoder is trained by the method of claim 1;
generate, by using the decoder and on the basis of query features, a classification confidence, regression information for characterizing a target position, and a predicted segment quality score; and
determine a prediction score on the basis of the classification confidence and the predicted segment quality score.

16. A non-transitory computer-readable storage medium having stored thereon computer instructions which, when executed by one or more processors, cause the one or more processors to:
generate, by using the relational attention module and on the basis of query features, a salient query feature set corresponding to the query features, to perform, by using the relational attention module and on the basis of the salient query feature set, updating processing on the query features;
acquire, by using the cross-attention module and on the basis of the updated query features, predicted segment quality information corresponding to the updated query features, and construct a segment quality loss function according to the predicted segment quality information;
acquire segment relation features between predicted video segments corresponding to the query features, and construct a segment relation loss function; and
perform adjustment processing on the relational attention module and the cross-attention module according to the segment quality loss function and the segment relation loss function.

17. The training apparatus of claim 13, wherein the generating a salient query feature set corresponding to the query features comprises:
acquiring, by using the relational attention module and on the basis of the query features, similarity information between the query features and segment relation feature information between video segments corresponding to the query features;
generating a similar feature set corresponding to the query features according to the similarity information;
generating a relation feature set corresponding to the query features according to the segment relation feature information; and
generating the salient query feature set on the basis of the similar feature set, the relation feature set, and the query features.

18. The training apparatus of claim 17, wherein the generating a similar feature set corresponding to the query features according to the similarity information comprises:
acquiring similar query features of the query features according to the similarity information, wherein a similarity between the query feature and the similar query feature is greater than a preset similarity threshold; and
generating the similar feature set on the basis of the similar query features.

19. The training apparatus of claim 17, wherein the segment relation feature information comprises a segment intersection-over-union, and the generating a relation feature set corresponding to the query features according to the segment relation feature information comprises:
acquiring relation query features of the query features according to the segment intersection-over-union, wherein the segment intersection-over-union between the query features and the relation query features is greater than a preset intersection-over-union threshold; and
generating the relation feature set on the basis of the relation query features.

20. The non-transitory computer readable storage medium of claim 16, wherein the generating a salient query feature set corresponding to the query features comprises:
acquiring, by using the relational attention module and on the basis of the query features, similarity information between the query features and segment relation feature information between video segments corresponding to the query features;
generating a similar feature set corresponding to the query features according to the similarity information;
generating a relation feature set corresponding to the query features according to the segment relation feature information; and
generating the salient query feature set on the basis of the similar feature set, the relation feature set, and the query features.

21. The non-transitory computer readable storage medium of claim 20, wherein the generating a similar feature set corresponding to the query features according to the similarity information comprises:
acquiring similar query features of the query features according to the similarity information, wherein a similarity between the query feature and the similar query feature is greater than a preset similarity threshold; and
generating the similar feature set on the basis of the similar query features.

22. The non-transitory computer readable storage medium of claim 20, wherein the segment relation feature information comprises a segment intersection-over-union, and the generating a relation feature set corresponding to the query features according to the segment relation feature information comprises:
acquiring relation query features of the query features according to the segment intersection-over-union, wherein the segment intersection-over-union between the query features and the relation query features is greater than a preset intersection-over-union threshold; and
generating the relation feature set on the basis of the relation query features.
